(19) United States
(12) Patent Application Publication
(10) Pub. No.: US 2026/0049803 A1
(43) Pub. Date: Feb. 19, 2026

(54) Tape measure with replaceable tape and reel cartridge assembly

(71) Applicant: Reekon Tools Inc., Boston, MA (US)

(72) Inventors: Konstantinos Oikonomopoulos, Boston, MA (US); Edgar Sutawika, Cambridge, MA (US)

(21) Appl. No.: 18/808,160

(22) Filed: Aug. 19, 2024

(51) Int. Cl. G01B 3/1007; G01B 3/1041; G01B 3/1061

(52) U.S. Cl. CPC G01B 3/1007; G01B 3/1041; G01B 3/1061

(57) ABSTRACT

This disclosure describes a self-contained, user-removable and replaceable tape and reel cartridge assembly that is easily loaded into a tape measure housing in a slide-in fashion. The spring of the reel is charged (tensioned) and is maintained in this state during the loading of the assembly so that the user does not need to adjust spring state during the replacement process. This is achieved by configuring the tape and reel cartridge assembly with a bracket that loops around the reel and is torsionally coupled to an arbor (the central hub) of the reel. The bracket prevents the tape from unwinding from the spool during the replacement operation. Once the tape and reel assembly is installed, the device housing is closed and the device is immediately available for use.

### BACKGROUND OF THE INVENTION

This disclosure relates generally to measuring devices and methods.

It is known in the prior art to augment a conventional tape measure device with measuring and processing components that enable greater accuracy to the measurements made by the device. One such example is described and depicted in U.S. Pat. No. 11,460,284, the disclosure of which is hereby incorporated by reference. In a representative embodiment, the device has a housing that supports a display on which measurements are rendered. To take a measurement, a tape measure is extended from the housing at a given distance of interest. The tape measure includes unit length markings. The device housing supports a positional encoder, a processor, and memory/storage that supports control software executed by the processor to control the device. In particular, the control software is configured to process positional information received from the positional encoder, compute a linear location of the measuring tape (its degree of extension from the housing, as measured by the unit length markings), and to generate one or more control signals to drive the display to render positional data

While a device such as described above provides significant advantages, the tape and reel components therein may fail or be damaged and need to be replaced over the device's useful life. In traditional mechanical tape measures, it has been possible to replace a reel. Typically, this requires a user to carefully disassemble the device and then insert a replacement reel along its axis of rotation, and to thereafter adjust the spring state. This is a very difficult and often unsuccessful repair process.

### SUMMARY OF THE INVENTION

This disclosure provides for a self-contained, user-removable and replaceable tape and reel cartridge assembly that is easily loaded into a tape measure housing in a slide-in fashion. The spring of the reel is charged (i.e., the spring is wound and in tension) during manufacture of the assembly, and it is maintained in this state during the loading of the assembly into the tape measure housing so that the user does not need to adjust spring state during the replacement process. This is achieved by configuring the tape and reel cartridge assembly with a bracket that loops around the reel and is torsionally-coupled to an arbor (the central hub) of the reel. The bracket prevents the tape from unwinding from the spool during the replacement operation. Once the tape and reel assembly is installed, the device housing is closed and the device is immediately available for use. In use, and as the user withdraws the tape from the device to take a measurement, the spring unwinds but remains in tension; once the tape has been withdrawn to a desired position, the user sets a lock on the housing. When the user then later releases the lock, the spring causes the tape measure to be pulled back into the device housing.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a self-contained, user-removable and replaceable tape and reel cartridge assembly of this disclosure;

FIG. 2 depicts a portion of the reel in cutaway showing the torsional coupling of the bracket to reel arbor;

FIG. 3 depicts the pre-loading (pre-charging) of the reel spring after the assembly is configured (e.g., typically at a factory);

FIG. 4 depicts a representative replacement operation wherein the tape and reel cartridge assembly is slide-in the device housing;

FIG. 5 depicts a cross-sectional view of the tape and reel cartridge assembly mounted within the housing following the replacement operation; and

FIG. 6 depicts the tape and reel cartridge assembly in one of two positions during use; in the upper figure the user has started to withdraw the tape; in the lower figure the user has withdrawn the tape to a desired position or location for a measurement.

### DETAILED DESCRIPTION OF THE INVENTION

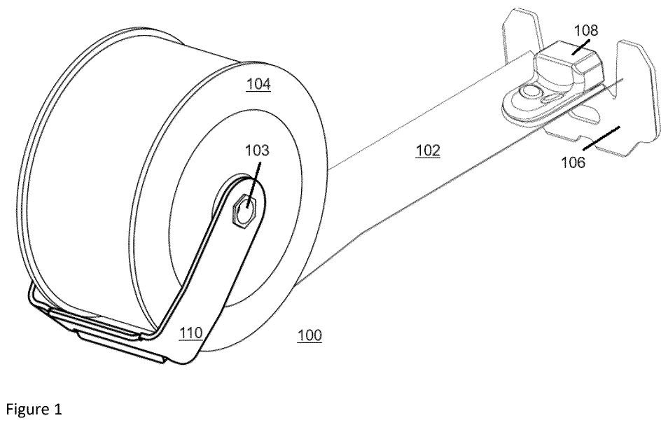

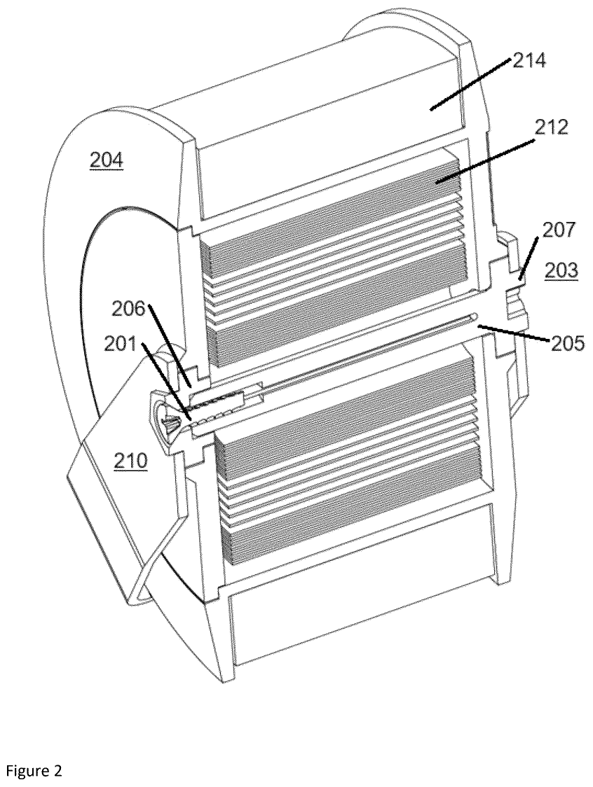

As noted above, the subject matter of this disclosure is a self-contained, user-removable and replaceable tape and reel cartridge assembly for a tape measure, such as a digital tape measure. The techniques herein are not limited to digital tape measures but may also be applied to conventional mechanical devices in which it is desired to replace the tape spool mechanism. As depicted in FIG. 1, the cartridge assembly 100 of this disclosure comprises a tape measure (tape) 102 that is wound about a reel 104. The reel has an arbor (a central hub) that is inside the unit and that supports a spring (see FIG. 2); an outer end 103 of the arbor is visible in this view. The spring 105 has a length that is the same as that of the tape measure. One end of the spring is attached to a slot in the arbor, and the other end of the spring is attached to the reel 104. The tape measure 102 has an end hook 106 secured to its distal end by a fastener 108.

As also seen, and according to this disclosure, the cartridge assembly 100 has a metal bracket 110 that is torsionally-coupled to the arbor's outer ends, one of which is end 106 as depicted. As will be described, the bracket 110 attaches to the arbor and prevents its rotation. Preferably, and in this embodiment (see FIG. 2), the arbor comprises two (2) parts, which facilitates the manufacture of the cartridge assembly with the spring in a charged condition. The notion of adding a charge or tension to the spring is sometimes referred to as loading or pre-loading. As will be seen, the inclusion of the bracket 110 that loops around the reel 104 allows for the overall assembly to be self-contained and that is pre-configured to ensure that the assembly is easily and readily position-able in an open housing of the tape measure. To this end, and as will described and depicted further below, after the unit's spring is pre-loaded, the bracket 110 is installed and torsionally-coupled to the arbor. In this configuration, the hook 106 of the tape measure prevents the tape from unwinding under the effect of the spring because the hook is stopped from rotating by the bracket 110. Additionally, the inclusion of the bracket 110 is further beneficial as it enables the loading of the cartridge assembly into the tape measure housing from any of the top, bottom or sides of the assembly and in a slide-in fashion, preferably perpendicularly to a rotation axis of the tape measure. This is contrasted to the traditional approach where the reel is inserted along its axis of rotation, which as noted above requires significant disassembly of the product to reach and perform. Given its position on the cartridge assembly 100, the bracket 110 does not mar or otherwise scratch the tape during the repair operation or otherwise in use.

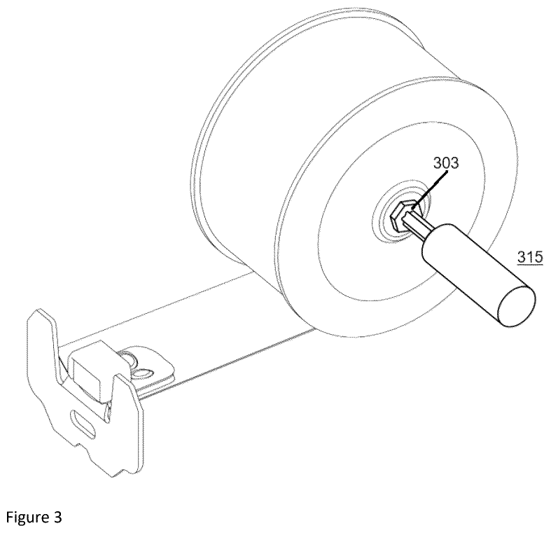

FIG. 2 depicts the reel 204 in a cutaway view showing the details of the two-piece arbor 203, namely, a first (or main) portion 205, and the second portion 206 that was depicted in FIG. 1. As shown, the second portion 206 is fitted onto the first portion 205 and maintained by fastener 201, and the arbor includes a similar outer end 207 (on its opposite side) integrally formed therein. During manufacture, the first portion 205 is slid into the reel, and the second portion 206 is fitted onto the first portion. The bracket 210 is also partially visible in this view. The bracket includes a cutout on each side that enables the bracket to be fitted over the respective ends of the arbor that project outside of the reel 204. Splitting the arbor in this manner allows the bracket 210 to be closed at both ends. In this configuration, the spring 212 inside the reel 204 is pre-loaded, e.g., by applying a hex key to the arbor and winding, and before the bracket 210 is assembled onto the unit. FIG. 3 depicts the charging of the spring using the hex key 315 and, in particular, by twisting the arbor 303. After the pre-loading of the spring 212, the bracket 210 is fitted on the arbor ends and stays fixed relative thereto. In this manner, the charge on the spring is then maintained. As noted above, the bracket's positioning relative to the tape measure hook also ensures that the tape cannot unwind as the assembly is fitted into the housing. This view also depicts the tape measure 214 wound on the reel 204.

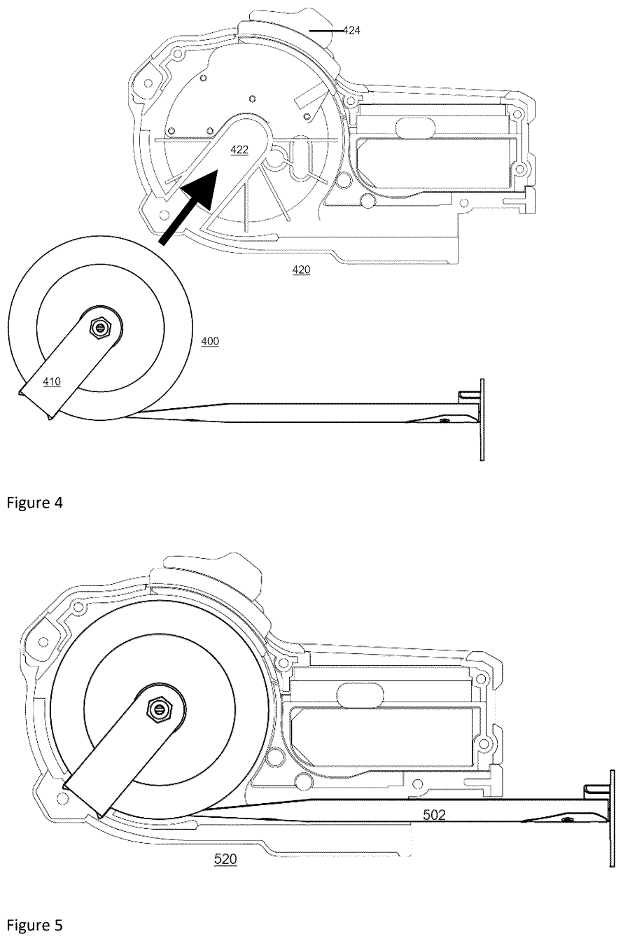

FIG. 4 depicts the loading of the cartridge assembly 400 into a housing 420 of a tape measure device. Further details regarding a representative tape measure device are described in U.S. Pat. No. 11,460,284, the disclosure of which is incorporated herein by reference. In this example embodiment, the housing 420 is configured for bottom loading of the cartridge assembly 400 within a receiving slot 422 formed within the device housing. As depicted, typically the receiving slot 422 is configured to the form factor of the bracket 410 on the cartridge assembly 400, although this is not a requirement. As depicted, and once the housing 420 is opened (and the tape and reel assembly removed), the self-contained, replaceable cartridge assembly 400 is slide-into the receiving slot 422. The tape measure also includes lock 424, which in this configuration is movable downward from the first position shown and into a locked position that maintains the tape measure at whatever position to which it has been withdrawn by the user. In such use, and as the user withdraws the tape from the device to take a measurement, the spring unwinds but remains in tension; once the tape has been withdrawn to a desired position, the user sets the lock 424 on the housing by moving it from the first position to the locked position. When the user then later releases the lock 424 (e.g., by moving it back to the first position), the spring causes the tape measure to be pulled back into the device housing.

As depicted in FIG. 5 (an internal view), the tape measure 502 is positioned with the housing 520, and the unit is then closed up for use. While the bottom loading is preferred, this configuration is not intended to be limiting, as other structural arrangements to facilitate top or side loading of the assembly may be used.

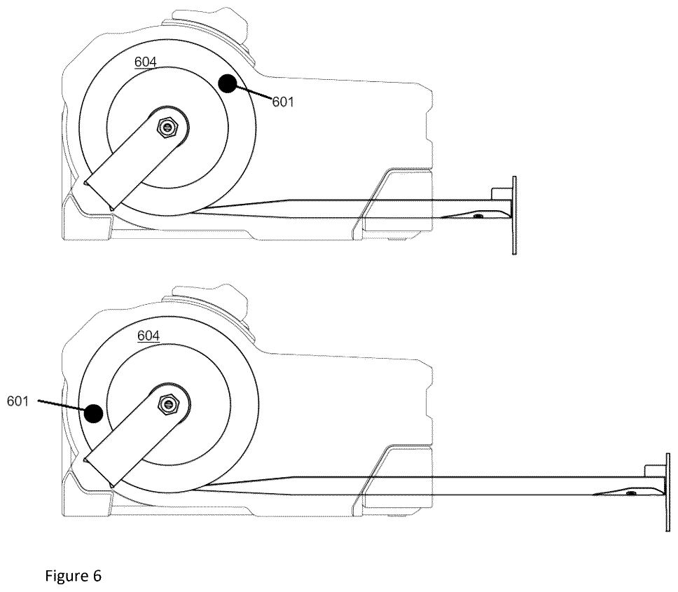

FIG. 6 depicts the rotation of the reel assembly as the tape measure is withdrawn from the housing. In the upper figure, the user has just started to withdraw the tape; in the lower figure, the tape has been withdrawn to its desired position, after which the user may then engage the lock downward to lock this position. As shown, during the process of withdrawing the tape measure from the housing the reel 604 rotates, and this rotation is exhibited by the movement of the identification marker 601. As the tape is withdrawn, the spring remains in tension. After the user has completed his or her measurement, the lock is released, and as described above the tape measure is then pulled back into the housing under the tension of the spring.

In FIG. 6, the identification marker 601 is readable by the electronic system components within the device. The marker, which may be a bar code or other similar marker, may store information about the assembly, such as blade type and revision, calibration, lot information, a code that is uniquely associated to the an absolute encoder strip on the tape measure, or the like. The identification marker 601 is not intended to be limiting, as the reel may also carry a separate chip or the like that can be read by a sensor, and the resulting data processed, stored and/or transmitted from the device.

The above-described embodiments provide significant advantages. The cartridge assembly is user-removable and replaceable, with little effort other than opening the housing, removing the current unit, and replacing that unit with the self-contained assembly described herein. With the above-described configuration, a user can swap out different tape artworks of their preference. A manufacturer of the device can ship new versions of the tape and reel that are backwards compatible with the hardware and other electronics within the measurement system.

While a multi-piece arbor has been described as a preferred implementation, this is not a requirement, as a one-piece arbor may also be used.

Having described the above-described subject matter, what we now claim is set forth below.

1. A cartridge assembly configured to be received with a housing of a tape measure, comprising:
a tape having a hook at one end;
a reel that supports the tape;
a spring positioned with the reel;
an arbor fitted within the reel along a central axis, the arbor having a first portion positioned along the central axis, and a second portion coupled to the first portion; and
a bracket configured on the reel, the bracket adapted to be fitted onto end portions of the arbor after the spring and the tape are pre-loaded within the reel.

2. The cartridge assembly as described in claim 1, wherein the hook is captured by the bracket to prevent unwinding of the tape by the spring.

3. The cartridge assembly as described in claim 1, wherein the bracket is configured to be received with a slot of the housing.

4. The cartridge assembly as described in claim 1, wherein the bracket is supported onto the end portions of the arbor and is affixed thereto.

5. The cartridge assembly as described in claim 1, wherein the bracket is positioned around a portion of the reel and is torsionally-coupled to the arbor.

6. The cartridge assembly as described in claim 1, wherein the reel includes an identification marker.

7. The cartridge assembly as described in claim 6, wherein the identification marker encodes information about one of: the reel, and the tape measure.

8. A measurement system, comprising:
a housing; and
a self-contained, removable and replaceable cartridge assembly that comprises a reel, a pre-loaded spring wound around an arbor having first and second outer ends, a tape carried by the reel, and a bracket positioned around a portion of the reel, the bracket torsionally coupled to the first and second arbor ends.

9. The measurement system as described in claim 8 wherein the arbor comprises a first portion positioned along a central axis of the reel, and a second portion coupled to the first portion.

10. The measurement system as described in claim 8, wherein the tape comprises a hook at a distal end.

11. The measurement system as described in claim 10, wherein the hook is captured by the bracket to prevent unwinding of the tape by the spring.

12. The measurement system as described in claim 8, wherein the housing includes a slot, the bracket being configured to be slidable within the slot.

13. The measurement system as described in claim 8, wherein the reel includes an identification marker.

14. The measurement system as described in claim 13, wherein the system includes a sensor to read information encoded in the information marker as the reel is rotated.

15. The measurement system as described in claim 8, wherein the spring remains under loading as the tape is withdrawn from the housing without losing charge.

16. The measurement system as described in claim 15, wherein the tape is configured to be pulled back into the housing under the loading of the spring.

17. The measurement system as described in claim 8, wherein the spring is attached at one end to the arbor, and wherein the spring is pre-loaded by applying a tensioning force to the arbor prior to positioning the bracket.
